(19) United States
(12) Patent Application Publication
(10) Pub. No.: US 2024/0342654 A1
(43) Pub. Date: Oct. 17, 2024

(54) PARTICULATE FILTER

(71) Applicants: CATALER CORPORATION, Kakegawa-shi, Shizuoka (JP); TOYOTA JIDOSHA KABUSHIKI KAISHA, Toyota-shi, Aichi (JP)

(72) Inventors: Kohei TAKASAKI, Kakegawa-shi (JP); Keisuke MURAWAKI, Kakegawa-shi (JP); Masatoshi IKEBE, Kakegawa-shi (JP); Takeshi MORISHIMA, Kakegawa-shi (JP); Takaya OTA, Kakegawa-shi (JP); Koji SUGIURA, Toyota-shi (JP); Takeshi HIRABAYASHI, Toyota-shi (JP); Akemi SATOU, Toyota-shi (JP)

(73) Assignees: CATALER CORPORATION, Kakegawa-shi, Shizuoka (JP); TOYOTA JIDOSHA KABUSHIKI KAISHA, Toyota-shi, Aichi (JP)

(21) Appl. No.: 18/701,056

(22) PCT Filed: Oct. 18, 2022
(86) PCT No.: PCT/JP2022/038763

§ 371 Date: Apr. 12, 2024

(30) Foreign Application Priority Data
Oct. 20, 2021 (JP) 2021-171637

(51) Int. Cl. B01D 53/94; B01D 46/24; B01J 21/04; B01J 23/10; B01J 35/56; B01J 35/57; B01J 37/02

(52) U.S. Cl. CPC B01D 53/94; B01D 46/2418; B01J 21/04; B01J 23/10; B01J 35/56; B01J 35/57; B01J 37/0215; B01D 2255/2092; B01D 2255/407; B01D 2255/908; B01D 2255/9155; B01D 2258/012; B01D 2258/014

(57) ABSTRACT

A wall-flow type particulate filter includes: a wall-flow type base material; and a coat layer formed on the base material. The base material includes: an inlet cell open only at an exhaust gas inlet end; an outlet cell open only at an exhaust gas outlet end; and a partition partitioning the inlet and outlet cells and having multiple pores through which the inlet and outlet cells communicate with each other. The coat layer is provided for the wall surfaces of the pores and contains a first inorganic oxide and a second inorganic oxide. The mean particle diameter Da of the first inorganic oxide is larger than the mean particle diameter Db of the second inorganic oxide. The weight ratio of the second inorganic oxide is designed to be from 10% to 50% inclusive when the total weight ratio of the first inorganic oxide and the second inorganic oxide is 100%.

### TECHNICAL FIELD

The present invention relates to a particulate filter. The present invention specifically relates to a particulate filter used to capture a particulate matter (PM) contained in exhaust gas exhausted from internal combustion engines of vehicles. The present application is based upon and claims the benefit of priority from Japanese patent application No. 2021-171637 filed on Oct. 20, 2021, and the entire disclosure of which is incorporated herein its entirety by reference.

### BACKGROUND ART

The exhaust gas exhausted from the internal combustion engines such as a vehicle engine contains hazardous gas components such as hydrocarbon (HC), carbon monoxide (CO), and nitrogen oxide (NOₓ), a particulate matter (PM), and the like. Thus, a particulate filter which can capture PM is disposed in an exhaust system of the internal combustion engine. In particular, in recent years, it has been proposed to provide a coat layer containing a catalyst (e.g., a catalyst metal such as Pt, Pd, and Rh) capable of oxidizing or reducing exhaust gas components for a particulate filter, for example, in order to impart an exhaust gas purification function in addition to the PM exhaust prevention function to the particulate filter.

Such a particulate filter includes, for example, a wall-flow type base material, and a catalyst coat layer formed on the base material. The wall-flow type base material includes: inlet cells each with an opening only at an exhaust gas inlet end; outlet cells each with an opening only at an exhaust gas outlet end, and porous partitions partitioning both cells. The catalyst coat layer is formed on the surfaces of and/or inside the partitions of the base material. Exhaust gas supplied to the particulate filter with such a structure flows into inlet cells, passes through the partitions, and exhausted from the outlet cells. At this time, PM is captured in the porous partitions, and exhaust gas components are purified by the catalyst coat layer formed on the partitions. For example, Patent Literature 1 discloses an example of such a configuration.

Further, for example, Patent Literature 2 discloses a catalyst article for purifying exhaust gas. The catalyst article includes a base material and a wash coat on the base material. The wash coat contains a catalytic component and a functional binder having a mean particle diameter of about 10 nm to about 1000 nm. It is said that by making the mean particle diameter of the catalytic component more than 10 times larger than that of the functional binder, a porous wash coat which does not virtually have cracks is achieved.

### CITATION LIST

### Patent Literatures

Patent Literature 1: WO 2016/060049
Patent Literature 2: Japanese Patent Publication of International Application No. 2018-503511

### SUMMARY OF INVENTION

The exhaust gas purification function can be imparted by forming a catalyst coat layer in the particulate filter. However, the catalyst coat layer causes flow paths for exhaust gas to be narrow, thereby increasing pressure drop. Therefore, a technology of reducing the pressure drop even when the catalyst coat layer is formed is desired.

The present invention was made in view of the circumstances described above, and the objective of thereof is to provide a wall-flow type particulate filter which can reduce an increase in pressure drop due to the formation of the coat layer.

In order to widen the flow paths for exhaust gas in pores of the partitions of the wall-flow type base material, the present inventors have focused on the void fraction of the coat layer formed on the wall surfaces of the pores. The “void fraction of the coat layer” refers to the percentage of voids per a predetermined volume of the coat layer. The lower the void fraction is, the more densely components (e.g., various inorganic oxides) contained in the coat layer are arranged. The present inventors conducted earnest studies based on the consideration that the flow paths for exhaust gas to pass therethrough become wider by reducing the void fraction of the coat layer. As a result, it was found that an increase in pressure drop due to formation of the coat layer can be reduced by mixing inorganic oxides having different mean particle diameters and keeping their weight ratio within a predetermined range.

That is, the particulate filter disclosed herein is a particulate filter used to capture a particulate matter in exhaust gas exhausted from an internal combustion engine. The particulate filter includes a wall-flow type base material and a coat layer formed on the base material. The base material includes: an inlet cell that is open only at an exhaust gas inlet end; an outlet cell that is open only at an exhaust gas outlet end; and a partition partitioning the inlet cell and the outlet cell and having multiple pores through which the inlet cell and the outlet cell communicate with each other. The coat layer is provided for the wall surfaces of the pores and contains a first inorganic oxide and a second inorganic oxide. The mean particle diameter Da of the first inorganic oxide is larger than the mean particle diameter Db of the second inorganic oxide. The weight ratio of the second inorganic oxide is designed to be from 10% to 50% inclusive when the total weight ratio of the first inorganic oxide and the second inorganic oxide is 100%.

With such a configuration, the void fraction of the coat layer can be reduced, and the flow path for exhaust gas can be widen, thereby reducing the increase in pressure drop.

In a preferred aspect of the particulate filter disclosed herein, the first inorganic oxide is a ceria-zirconia composite oxide, and the second inorganic oxide is alumina. With such a configuration, the void fraction of the coat layer is more suitably reduced, an increase in pressure drop can be further reduced.

In another preferred aspect, the weight ratio of the second inorganic oxide is from 20% to 30% inclusive. With such a configuration, and the increase in pressure drop can be further reduced.

In a preferred aspect of the particulate filter disclosed herein, the coat layer contains a catalyst metal functioning as a catalyst which is capable of oxidizing or reducing at least one exhaust gas component in exhaust gas. With such a configuration, the exhaust gas purification function is imparted to the coat layer, which contributes to not only capturing of PM but also purification of exhaust gas components.

### BRIEF DESCRIPTION OF DRAWINGS

FIG. 1 is a schematic view of an example exhaust system in which a particulate filter according to a first embodiment is disposed.

FIG. 2 is a schematic perspective view of the particulate filter according to the first embodiment.

FIG. 3 is a schematic sectional view of the particulate filter according to the first embodiment along a cylinder axis direction.

FIG. 4A is a schematic enlarged sectional view of a partition of a base material in the particulate filter according to the first embodiment.

FIG. 4B is a schematic enlarged sectional view of an example partition of a base material in a known particulate filter.

FIG. 5 is a graph illustrating a relationship between a small particle diameter weight ratio and a pressure drop ratio.

### DESCRIPTION OF EMBODIMENTS

Embodiments of the particulate filter disclosed herein will be described below with reference to the accompanying drawings as appropriate. The matters necessary for executing the present technology, except for matters specifically herein referred to can be grasped as design matters of those skilled in the art based on the related art in the preset field. The present technology can be executed based on the contents disclosed herein and the technical knowledge in the present field. The expression “A to B” indicating herein a numerical range means from A to B inclusive, and encompasses a range which is larger than A and smaller than B.

### Exhaust System of Internal Combustion Engine

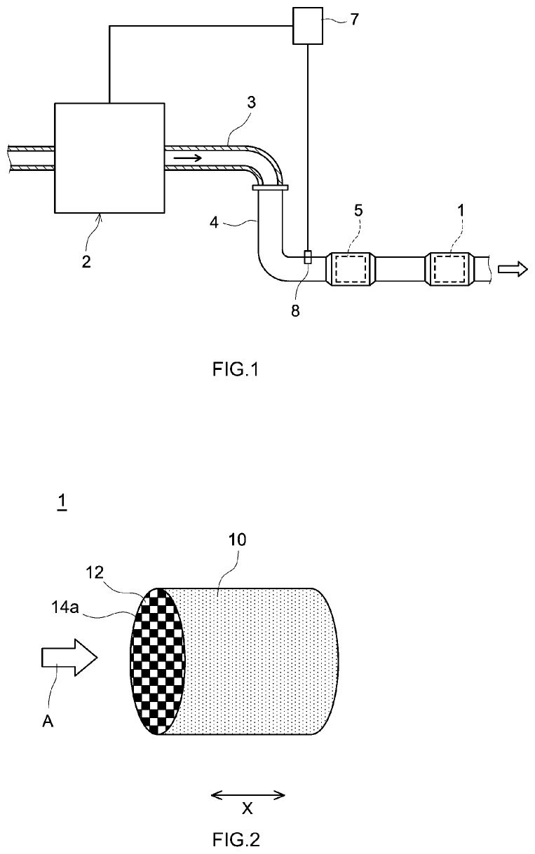

First, an exhaust system in which the particulate filter disclosed herein can be used suitably will be described. FIG. 1 is a schematic view of an example exhaust system in which the particulate filter is disposed. In FIG. 1, an exhaust gas purification catalyst 5 and a particulate filter 1 are disposed in an exhaust system (exhaust pipe 4) of an internal combustion engine (engine) 2.

To the internal combustion engine 2, an air-fuel mixture containing oxygen and fuel gas is supplied. The internal combustion engine 2 combusts the air-fuel mixture to generate mechanical energy. The internal combustion engine 2 mainly includes an gasoline engine, for example. The internal combustion engine 2 may be an engine (e.g., a diesel engine) other than the gasoline engine.

The exhaust gas produced by the combustion of the air-fuel mixture in the internal combustion engine 2 is discharged into the exhaust system including an exhaust manifold 3 and an exhaust pipe 4, as shown by the arrow in FIG. 1. In this specification, for convenience of explanation, a side near the internal combustion engine 2 in a direction in which the exhaust gas distributes is referred to as an upstream side, and a side farther from the internal combustion engine 2 is referred to as a downstream side.

The exhaust pipe 4 is equipped with a sensor 8 for detecting information about components and temperatures of the exhaust gas. The sensor 8 is connected to an engine control unit (ECU) 7. Information detected by the sensor 8 is sent to the ECU 7, and used as a piece of information for correcting operation control of the internal combustion engine 2.

Gas exhausted to the exhaust pipe 4 passes through the exhaust gas purification catalyst 5 and the particulate filter 1 and is exhausted to the outside of the exhaust system. Since the exhaust gas purification catalyst 5 contains a catalyst metal (e.g., Pt, Pd, and Rh) which is capable of oxidizing or reducing hazardous gas components (NOₓ, HC, and CO) in exhaust gas, the exhaust gas components in the exhaust gas can be purified. Further, when exhaust gas passes through the particulate filter 1, PM is captured. In the case where the particulate filter 1 contains a particulate filter 1, when exhaust gas passes through the particulate filter 1, exhaust gas components can be purified.

In FIG. 1, the exhaust gas purification catalyst 5 is disposed upstream of the particulate filter 1, but may be disposed downstream of the particulate filter 1. Further, in FIG. 1, one kind of exhaust gas purification catalyst 5 is disposed in an exhaust system as a catalyst, but two or more kinds of catalyst may be disposed. For example, an underfloor catalyst or the like may be disposed downstream of the exhaust gas purification catalyst 5. In such a case, the position in which the particulate filter 1 is disposed is not particularly limited, and the particulate filter 1 may be disposed upstream or downstream of the underfloor catalyst.

### Particulate Filter

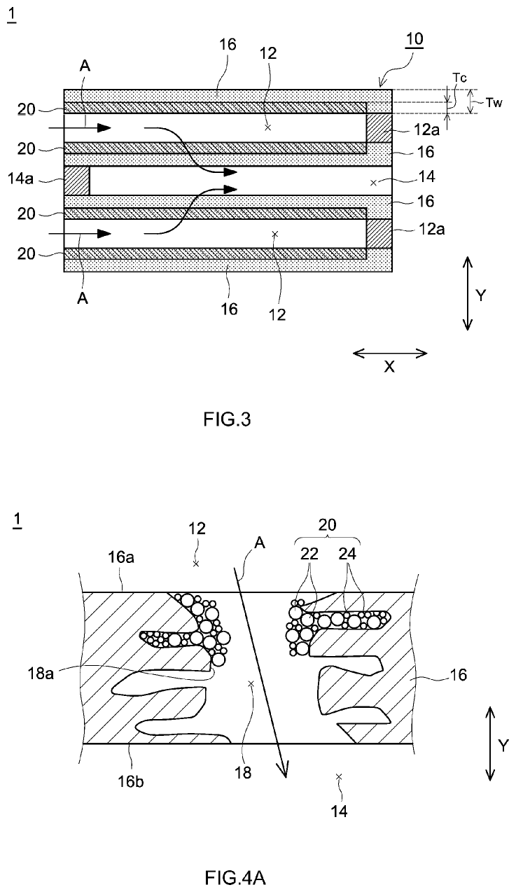

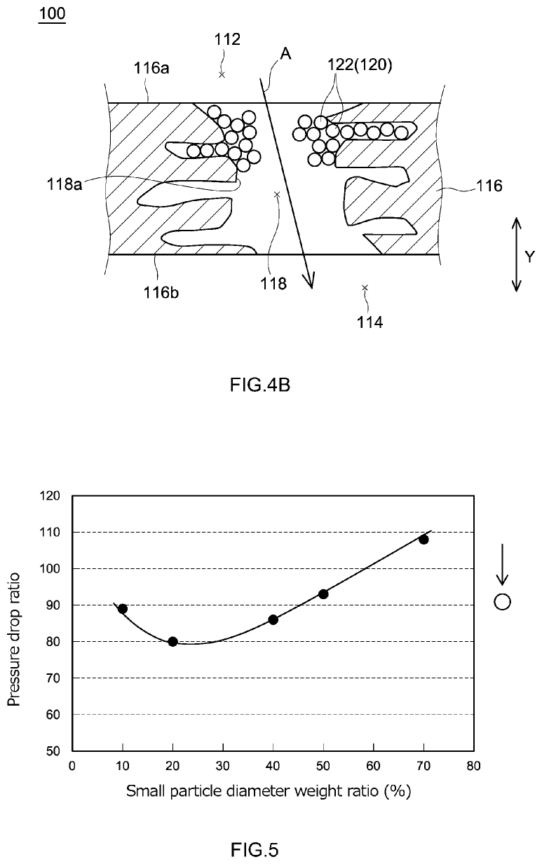

An embodiment of the particulate filter 1 will be described in detail below. FIG. 2 is a schematic perspective view of the particulate filter according to the first embodiment. FIG. 3 is a schematic sectional view of the particulate filter according to the first embodiment along a cylinder axis direction. FIG. 4A is a schematic enlarged sectional view of a partition of a base material in the particulate filter according to the first embodiment. The reference sign A in each drawing referred to herein indicates the “direction in which exhaust gas distributes.” The reference sign X indicates the “direction in which the partition extends,” and the reference sign Y indicates the “thickness direction of the partition of the base material.”

As shown in FIGS. 2 and 3, the particulate filter 1 includes a base material 10 and a coat layer 20. Each component will be described below.

### 1. Base Material

The base material 10 constitutes the framework of the particulate filter. As shown in FIG. 2, in the present embodiment, a cylindrical base material 10 extending along the direction A in which the exhaust gas distributes is used. The outside shape of the base material is not limited to cylindrical, and may be elliptic cylindrical, polygonal, or the like. The overall length and capacity of the base material 10 are also not particularly limited, and can be changed, as appropriate, according to the performance of the internal combustion engine 2 (see FIG. 1), dimensions of the exhaust pipe 4, and the like. In the base material 10, known materials that can be used in base materials of particulate filters can be used without particular limitations. Examples of the materials of the base material 10 include highly heat resistance materials, namely ceramics such as cordierite, silicon carbide (SiC), and aluminum titanate and alloys such as stainless steel. For example, cordierite has excellent durability against thermal shock, and thus can be particularly suitably used as a material of the base material of the gasoline particulate filter (GPF) to which high-temperature exhaust gas is prone to be supplied.

The base material 10 of the present embodiment is a wall-flow type base material. Specifically, as shown in FIGS. 2 and 3, the base material 10 includes: inlet cells 12 each with an opening at an exhaust gas inlet end; outlet cells 14 each with an opening at an exhaust gas outlet end, and porous partitions 16 partitioning both the inlet cells 12 and the outlet cells 14. Specifically, the inlet cells 12 are each a gas flow path which is open at the exhaust gas inlet end and has an exhaust gas outlet end closed with a sealing portion 12a. The outlet cells 14 are each a gas flow path which has an exhaust gas outlet end closed with a sealing portion 14a and is open at the exhaust gas outlet end. The partitions 16 are each a partitioning material with multiple fine pores through which exhaust gas can pass. The partition 16 has multiple fine pores 18 (see FIG. 4A) through which the inlet cell 12 and the outlet cell 14 communicate with each other. In the particulate filter 1 according to the present embodiment, the shape of each inlet cell 12 (outlet cell 14) in cross section perpendicular to the stretching direction X of the partition 16 is square (see FIG. 2). However, the shape of the inlet cell (outlet cell) in the cross section perpendicular to the stretching direction is not limited to square, and various shapes can be employed. The shape may be, for example, any of various geometric shapes, namely a quadrilateral such as parallelogram, rectangle, trapezoid; other polygons (e.g., triangle, hexagonal, octagonal); and circular.

The partition 16 of the base material 10 is preferably formed in consideration of the PM capturing performance and the pressure drop suppression function. For example, the thickness of the partition 16 is preferably about 100 μm to about 350 μm. The porosity of the partition 16 is preferably about 20 vol % to about 70 vol %, more preferably 50 vol % to 70 vol %. In view of ensuring sufficient air permeability of the partition 16 and reducing an increase in pressure drop, the average pore diameter of the pores 18 is preferably 8 μm or more, more preferably 12 μm or more, yet more preferably 15 μm or more. In view of ensuring appropriate PM capturing performance, the upper limit of the average pore diameter of pores 18 is preferably 30 μm or less, more preferably 25 μm or less, yet more preferably 20 μm or less. The porosity and the average pore diameter of the partition 16 are measured by mercury intrusion technique.

### 2. Coat Layer

As shown in FIGS. 3 and 4A, the coat layer 20 is formed on the wall surfaces 18a of the pores 18 in the partition 16 of the base material 10. In the present embodiment, the coat layer 20 is provided in predetermined areas from the surfaces (inlet surfaces 16a) of the partition 16 in contact with the inlet cells 12 toward the surfaces (outlet surfaces 16b) of the partition 16 in contact with the outlet cells 14.

The coat layer 20 contains a first inorganic oxide 22 and a second inorganic oxide 24. The coat layer 20 is porous due to gathering of the first inorganic oxide 22 and the second inorganic oxide 24.

The coat layer 20 may contain a catalyst metal functioning as a catalyst capable of oxidizing or reducing at least one exhaust gas component. Typically, such a catalyst metal is carried on the first inorganic oxide 22 and/or the second inorganic oxide 24. This can further impart the exhaust gas purification performance to the coat layer 20. Examples of the catalyst metal include metals belonging to platinum group elements such as palladium (Pd), rhodium (Rh), platinum (Pt), ruthenium (Ru), osmium (Os), and iridium (Ir) or other metals that function as oxidization catalysts or reduction catalysts. Among them, Pd and Pt have excellent purifying performance (oxidation purifying performance) for carbon monoxide and hydrocarbon, and Rh has excellent purifying performance (reduction purifying performance) for NOₓ. Thus, they are particularly preferable catalyst metals. In addition to these, metals such as barium (Ba), strontium (Sr), other alkaline earth metals, alkali metals, transition metals, and the like may be used as cocatalyst components. The mean particle diameter of the catalyst metal by electron microscopy is preferably 0.5 nm to 50 nm, more preferably 1 nm to 20 nm, but is not particularly limited.

The first inorganic oxide 22 and the second inorganic oxide 24 may each be an inorganic oxide which can carry catalyst metals or an inorganic oxide (so-called OSC material) having oxygen storage capacity (OSC) for storing and releasing oxygen. Examples of the inorganic oxide which can carry catalyst metals include alumina (Al₂O₃), ceria (CeO₂), zirconia (ZrO₂), silica (SiO₂), and titania (TiO₂). The inorganic oxide which can carry catalyst metals can also be rare-earth metal oxides such as yttria (Y₂O₃), alkali metal oxide, and alkali earth metal oxide. Examples of the OSC material include ceria-zirconia composite oxides (CZ or ZC composite oxide). The OSC material may function as a cocatalyst for purifying exhaust gas. Thus, the OSC material is preferably employed as at least one of the first inorganic oxide 22 or the second inorganic oxide 24. In view of improving heat resistance, the OSC material such as ceria and a ceria-zirconia composite oxide, containing trace amounts of oxides that contains yttrium (Y), lanthanum (La), niobium (Nb), praseodymium (Pr), and other rare earth elements is preferably employed. The first inorganic oxide 22 and the second inorganic oxide 24 are typically different inorganic oxides, but may be the same kind of inorganic oxide.

As shown in FIG. 4A, in the present embodiment, the first inorganic oxide 22 and the second inorganic oxide 24 are particles. The first inorganic oxide 22 and the second inorganic oxide 24 may be secondary particles made by gathering of primary particles. The “primary particles” herein refer to fine particles forming secondary particles by gathering due to aggregation or sintering.

The first inorganic oxide 22 has a different mean particle diameter from the second inorganic oxide 24. The mean particle diameter Da of the first inorganic oxide 22 is designed to be larger than the mean particle diameter Db of the second inorganic oxide 24 (i.e., Da>Db). The weight ratio of the second inorganic oxide 24 is designed to be from 10% to 50% inclusive when the total weight ratio of the first inorganic oxide 22 and the second inorganic oxide 24 is 100%. The present inventors found that pressure drop can be reduced by designing the first inorganic oxide 22 and the second inorganic oxide 24 as described above. The following describes a comparison with the coat layer of the known particulate filter.

FIG. 4B is a schematic enlarged sectional view of an example partition of a base material in a known particulate filter. In the known particulate filter 100 shown in FIG. 4B, a coat layer 120 is formed on a wall surface 118a of each pore 118 in a partition 116 of the base material. The coat layer 120 is provided in a predetermined area from the surface of the partition 116 in contact with an inlet cell 112 toward the surface (outlet surface 116b) of the partition 116 in contact with an outlet cell 114. The coat layer 120 contains one type of inorganic oxide 122, and is porous due to gathering of the inorganic oxide 122.

When exhaust gas flows from the inlet cells 112 to the outlet cells 114 through the pores 118, an inorganic oxide 122 is gathered in a portion where the coat layer 120 is formed, so that exhaust gas cannot smoothly pass through the portion. Therefore, when the coat layer 120 is thick from the wall surface 118a of the pore 118, the rate of the exhaust gas passing through the coat layer 120 becomes high, thereby increasing the pressure drop. In other words, the diameter of each pore surrounded by the coat layer 120 becomes small, thereby increasing the pressure drop.

As illustrated in FIG. 4B, in the coat layer 120 formed by gathering one kind of inorganic oxide 122, relatively large voids are easily formed between the inorganic oxide 122, so that the void fraction of the coat layer 120 tends to be high. This increases the thickness of the coat layer 120 from the wall surface 118a of the pore 118, thereby narrowing the center portion having a diameter of the pore through which exhaust gas can flow smoothly. This makes it difficult for exhaust gas to flow from the inlet cells 112 to the outlet cells 114, thereby increasing pressure drop.

In the particulate filter 1 disclosed herein, the coat layer 20 contains a first inorganic oxide 22 and a second inorganic oxide 24 which have different mean particle diameters, thereby reducing voids in the coat layer 20 and reducing a void fraction of the coat layer 20. Therefore, even if the coat layer 20 having the same coating amount as in the known coat layer 120 is formed, the thickness of the coat layer 20 from the wall surface 18a of the pore 18 can be smaller than the known coat layer 120. This makes it possible to cause exhaust gas to easily flow from the inlet cells 112 to the outlet cells 114, thereby further reducing pressure drop than before. Further, as a result of earnest studied by the present inventors, it was found that the effect of reducing pressure drop is significantly exhibited when the weight ratio of the second inorganic oxide 24 having a smaller mean particle diameter is from 10% to 50% inclusive.

The first inorganic oxide 22 and the second inorganic oxide 24 are only necessary to have mean particle diameters with which they can enter the pores 18 and which are in the range of mean particle diameters of the inorganic oxides which can be contained in the coat layer formed on the wall surfaces of the pores of the known particulate filters. Thus, although not particularly limited thereto, the mean particle diameter of each of the first inorganic oxide 22 and the second inorganic oxide 24 is, for example, in the range from 0.1 μm to 10 μm, preferably from 0.5 μm to 5 μm.

The ratio between the mean particle diameter Da of the first inorganic oxide 22 and the mean particle diameter Db of the second inorganic oxide 24 (a value obtained by dividing Da by Db: Da/Db) is 1<Da/Db, preferably 1.5≤Da/Db, more preferably 1.8≤Da/Db (for example, 2≤Da/Db). This allows more suitable reduction in porosity of the coat layer 20. The upper limit of Da/Db is not particularly limited and is, for example, Da/Db≤5, Da/Db≤3, or Da/Db≤2.5.

Although not particularly limited thereto, the mean particle diameter Da of the first inorganic oxide 22 is, for example, 1.5 μm to 5 μm, preferably 1.5 μm to 3 μm, more preferably 1.5 μm to 2.5 μm (e.g., 1.7 μm to 2.3 μm).

Although not particularly limited thereto, the mean particle diameter Db of the second inorganic oxide 24 is, for example, 0.5 μm to 1.5 μm, preferably 0.7 μm to 1.3 μm, more preferably 0.8 μm to 1.2 μm (e.g., 0.9 μm to 1.1μ m).

The “mean particle diameter” herein is a cumulative 50% particle diameter (D50) in a volume-based particle size distribution measured by particle size distribution measuring apparatus based on laser diffraction scattering. Specifically, as the mean particle diameter, a value measured using a laser diffraction/scattering particle size distribution analyzer (LA-920 manufactured by HORIBA, Ltd.) with the refractive index set to 1.20+0.01i (i is the imaginary term) can be employed. Note that the mean particle diameter is a value calculated by encompassing the particle diameters of secondary particles.

The weight ratio of the second inorganic oxide 24 is preferably from 10% to 50% inclusive, more preferably from 10% to 40% inclusive, yet more preferably from 20% to 30% inclusive when the total weight ratio of the first inorganic oxide 22 and the second inorganic oxide 24 is 100%. When the weight ratio of the second inorganic oxide 24 is within such a range, the void fraction of the coat layer 20 is appropriately controlled, and the pressure drop is suitably reduced.

In a suitable example, the first inorganic oxide 22 is a ceria-zirconia composite oxide, and the second inorganic oxide 24 is alumina. With such a configuration, when the weight ratio of the second inorganic oxide 24 (alumina) is designed to be from 20% to 30% inclusive, a pressure drop can be particularly significantly reduced.

Although not particularly limited thereto, the coating amount of the coat layer 20 per 1 L of the base material 10 is, for example, 20 g/L or more, 30 g/L or more, or 50 g/L or more. For example, when the coating amount of the coat layer 20 is within such a range in the case where the coat layer 20 contains a catalyst metal, the exhaust gas purification performance is improved, which is suitable. In view of reducing the pressure drop, the upper limit of the forming amount of the coat layer 20 is preferably 200 g/L or less, more preferably 150 g/L or less, yet more preferably 120 g/L or less. The volume of the base material 10 herein refers to a bulk volume including the volumes of voids such as inlet cells 12, outlet cells 14, and pores 18 of partitions in addition to the net volume of the base material 10.

Although not particularly limited thereto, in the thickness direction Y of the partition 16 of the base material 10, the proportion of the region (thickness Tc) in which the coat layer 20 is formed is, for example, 10% or more, 20% or more, or 30% or more when the thickness Tw of the partition 16 is 100%. This allows the effects of the catalyst metal and the OSC material contained in the coat layer 20 to be effectively exhibited. In view of reducing an increase in pressure drop, the proportion of the coat layer 20 formed may be, for example, 80% or less, 70% or less, 60% or less, 50% or less of the thickness Tw of the partition 16.

Although not particularly limited thereto, the proportion of the region (length) in which the coat layer 20 may be formed is, for example, 10% or more, 30% or more, 50% or more, 70% or more, 90% or more (e.g., 100%) when the overall length of the partition of the inlet cell 12 in the stretching direction X is 100%. The present technology allows for reduction in increase of pressure drop even if the region in which the coat layer 20 is formed is wide. Typically, the coat layer 20 is formed from the exhaust gas outlet end toward the exhaust gas outlet end of the base material 10. In such a case, the proportion of the region (length) in which the coat layer 20 is formed refers to the proportion of the length from the exhaust gas inlet end.

### Manufacturing Method for Particulate Filter

A manufacturing method for a particulate filter 1 according to the present embodiment will be described below. Note that the manufacturing method for the particulate filter 1 is not limited to the following method.

### (1) Preparation of Slurry

First, materials of the coat layer 20 is dispersed in a predetermined dispersion medium to prepare a slurry. The dispersion medium used is a dispersion medium which can be used for preparation of this kind of slurry without limitations. For example, the dispersion medium may be a polar solvent (e.g., water) or a nonpolar solvent (e.g., methanol). The slurry may contain an viscosity adjusting organic component in addition to the materials of the coat layer 20 and the dispersion medium. Examples of the viscosity adjusting organic component include cellulose-based polymers such as carboxymethyl cellulose (CMC), methyl cellulose (MC), hydroxypropyl methylcellulose (HPMC), and hydroxyethyl methylcellulose (HEMC). The region in which the coat layer 20 is formed can be controlled easily by adjusting the viscosity of the slurry by the viscosity adjusting organic component of this type at a certain amount.

The first inorganic oxide 22 and the second inorganic oxide 24 can be adjusted to have desired mean particle diameters by being subjected to milling processing in the dispersion medium according to the known method. Such processing is preferably performed separately for a prepared slurry containing the first inorganic oxide 22 and a prepared slurry containing the second inorganic oxide 24. Then, these slurries are mixed so that the first inorganic oxide 22 and the second inorganic oxide 24 have a desired mass ratio. If the first inorganic oxide 22 and the second inorganic oxide 24 can be adjusted to have desired mean particle diameters, a slurry in which the first inorganic oxide 22 and the second inorganic oxide 24 are mixed may be subjected to milling processing. The milling processing can be processing using, for example, a bead mill or a ball mill.

### (2) Introduction of Slurry

Next, the prepared slurry is introduced into pores 18 of partitions 16 to form a coat layer 20. A means for introducing the slurry into the pores 18 is not particularly limited, and known means may be used without particular limitations. Examples of the means for introducing the slurry include air blowing and suction coating. In the air blowing, an end of the base material 10 is immersed in the slurry to allow the slurry to penetrate into the inlet cells 12, and the base material 10 is then taken out and air-blowed, thereby introducing the slurry into the pores 18. In the suction coating, the exhaust gas inlet end of the base material 10 is immersed in the slurry, and in this state, the exhaust gas outlet end is sucked, thereby introducing the slurry into the pores 18. In the suction coating, suction force is controlled to adjust the region coated with the slurry.

Thereafter, the resultant is fired at a predetermined temperature for a predetermined time, thereby forming a coat layer 20 on wall surfaces 18a of the pores 18 in the partitions 16 of the base material 10. The firing conditions for the slurry with which the base material 10 is coated vary according to the shape and size of the base material or the inorganic oxides and thus are not particularly limited, but typically, an intended coat layer 20 can be formed by performing firing at about 400° C. to about 1000° C. for about 1 hour to about 5 hours.

Embodiments of the particulate filter disclosed herein have been described above. Note that the particulate filter disclosed herein is not limited to the embodiments. For example, in the embodiment shown in FIG. 3, the coat layer 20 is formed in a predetermined region from the surface (inlet surface 16a) of each partition 16 in contact with each inlet cell 12 toward the outlet cell 14, but the coat layer 20 may be formed in a predetermined region from the surface (the outlet surface 16b) of the partition 16 in contact with the outlet cell 14 toward the inlet cell 12. In such a case, instead of introducing a slurry for forming a coat layer from the inlet cell 12, the slurry is introduced from the outlet cells 14, and thus, the case is understood by reading the inlet cell 12 in the description of the region in which the coat layer 20 is formed in the embodiment as the outlet cell 14. Further, the coat layer 20 may be formed from both the inlet surface 16a and the outlet surface 16b of the partition 16.

In the embodiment shown in FIG. 3, the particulate filter 1 does not include a coat layer other than the coat layer 20. However, for example, the particulate filter 1 may include a coat layer formed on the surface of the partition 16 (e.g., a catalyst layer containing a catalyst metal).

The particulate filter disclosed herein can be used as a gasoline particulate filter (GPF), a diesel particulate filter (DPF), or the like, and is particularly used as GPF.

Examples regarding the technology disclosed herein will be described below. However, it is not intended that the present disclosure is limited to such examples.

### Test 1

### <Sample 1>

First, as a base material, a wall-flow type, cylindrical honeycomb base material (made of cordierite, the number of cells: 300 cpsi, thickness of partition: 8 mill (1 mill/1000 inch), average pore diameter: 15 μm, porosity: 60%) having a base material volumetric capacity of 1.314 L and a length of 122 mm was prepared.

Next, a ceria-zirconia composite oxide (ZC material) and alumina were prepared as two kinds of inorganic oxides to be mixed into a slurry for forming a coat layer. The ZC material was milled in pure water to prepare a ZC material-containing slurry containing the ZC material having a mean particle diameter of 1 μm. Alumina was similarly milled in pure water to prepare an alumina-containing slurry containing alumina having an average particle size of 1 μm. The ZC material-containing slurry and the alumina-containing slurry were mixed to have a weight ratio ZC material:alumina=80%:20%. Thus, the slurry for forming the coat layer was produced.

Then, the produced slurry for forming a coat layer was introduced into the prepared base material from inlet cells, and unnecessary slurry was blown away with a blower. Thus, the wall surfaces of pores in the partitions were coated with the slurry for forming a coat layer.

Next, the base material was dried for two hours by a dryer set at 120° C. to remove moisture. Then, the base material was fired at 500° C. for two hours. Thus, a particulate filter of Sample 1 was produced. In Sample 1, the coating amount of the ZC material was 80 g/L, and the coating amount of alumina was 20 g/L per 1 L of the volumetric capacity of the base material.

### <Sample 2>

A particulate filter of Sample 2 was produced in the same manner as in Sample 1 except that the mean particle diameter of alumina was changed to 2 μm.

### <Sample 3>

A particulate filter of Sample 3 was produced in the same manner as in Sample 1 except that the mean particle diameter of the ZC material was changed to 2 μm.

### Evaluation of Pressure Loss

Air at 20° C. was allowed to flow into inlet cells of the particulate filter of each Sample at 7 m³/min, and discharged from the outlet cells. The pressure of the air on the upstream side of and the pressure of the air on the downstream side of the particulate filter were measured using a pressure drop measurement device (manufactured by TSUKUBARIKASEIKI Co., Ltd.) to calculate pressure drop (kPa). Table 1 shows relative values (pressure drop ratios) when the pressure drop of the particulate filter of Sample 1 is 100.

TABLE 1

| | Mean particle diameter (μm) | | Weight ratio (%) | | Pressure |
|---|---|---|---|---|---|
| | ZC | Almina | ZC | Alumina | drop ratio |
| Sample 1 | 1 | 1 | 80 | 20 | 100 |
| Sample 2 | 1 | 2 | 80 | 20 | 104 |
| Sample 3 | 2 | 1 | 80 | 20 | 80 |

As shown in Table 1, the pressure drop ratio of Sample 3 was lower than those of Samples 1 and 2. The coating amounts and the weight ratios of the ZC material and the alumina in Samples 1 to 3 were constant, so that the difference in pressure drop is considered to be caused by the difference in mean particle diameter between the ZC material and the alumina.

### Test 2

Next, a change in pressure drop when the weight ratio between the inorganic oxide (ZC material) having a larger particle diameter and an inorganic oxide (alumina) having a smaller particle diameter was changed was considered.

### <Sample 4>

A particulate filter of Sample 4 was produced in the same manner as in Sample 3 except that the coating amount of the ZC material per 1 L of the volumetric capacity of the base material was changed to 50 g/L and the coating amount of the alumina per 1 L of the volumetric capacity of the base material was changed to 50 g/L. In other words, the weight ratio was ZC material:alumina=50%:50%.

### <Sample 5>

A particulate filter of Sample 5 was produced in the same manner as in Sample 3 except that the coating amount of the ZC material per 1 L of the volumetric capacity of the base material was changed to 30 g/L and the coating amount of the alumina per 1 L of the volumetric capacity of the base material was changed to 70 g/L. In other words, the weight ratio was ZC material:alumina=30%:70%.

### <Sample 6>

A particulate filter of Sample 6 was produced in the same manner as in Sample 3 except that the coating amount of the ZC material per 1 L of the volumetric capacity of the base material was changed to 90 g/L and the coating amount of the alumina per 1 L of the volumetric capacity of the base material was changed to 10 g/L. In other words, the weight ratio was ZC material:alumina=90%:10%.

<Sample 7>

A particulate filter of Sample 7 was produced in the same manner as in Sample 3 except that the coating amount of the ZC material per 1 L of the volumetric capacity of the base material was changed to 60 g/L and the coating amount of the alumina per 1 L of the volumetric capacity of the base material was changed to 40 g/L. In other words, the weight ratio was ZC material:alumina=60%:40%.

For Samples 4 to 7, the pressure drop was evaluated in the same manner as in Test 1. The results are shown in Table 2 and FIG. 5. The pressure drop ratio was shown as a relative value when the pressure drop of Sample 1 is 100.

TABLE 2

| | Mean particle diameter (μm) | | Weight ratio (%) | | Pressure |
|---|---|---|---|---|---|
| | ZC | Alumina | ZC | Alumina | drop ratio |
| Sample 3 | 2 | 1 | 80 | 20 | 80 |
| Sample 4 | | | 50 | 50 | 93 |
| Sample 5 | | | 30 | 70 | 108 |
| Sample 6 | | | 90 | 10 | 89 |
| Sample 7 | | | 60 | 40 | 86 |

As can be seen from Table 2 and FIG. 5, the weight ratio of alumina having a smaller particle diameter was 10% to 50%, the pressure drop was 93 or less, indicating that the pressure drop ratio decreased. When the weight ratio of alumina is 10% to 40%, the pressure drop ratio can more decrease. It can also be seen that when the weight ratio of alumina was 20% to 30%, the pressure drop ratio particularly decreased.

Although specific examples of the technology disclosed herein have been described in detail above, they are mere examples and do not limit the appended claims. The technology described is the appended claims include various modifications and changes of the foregoing specific examples. For example, in specific examples described above, inorganic oxides which do not carry a catalyst metal were used, but it can be seen from technical information disclosed herein that the pressure drop ratio decreases even when inorganic oxides carrying a catalyst metal. For example, in specific examples described above, the coat layer was formed on the wall surface of each pore in the partitions on the inlet cell side, but it can be seen from the technical information disclosed herein that the pressure drop ration decreases even when the coat layer is formed on the wall surface of each pore in the partitions on the outlet cell side.

1. A particulate filter used to capture a particulate matter in exhaust gas exhausted from an internal combustion engine, the particulate filter comprising:
a wall-flow type base material; and
a coat layer formed on the base material,
the base material including:
an inlet cell that is open only at an exhaust gas inlet end;
an outlet cell that is open only at an exhaust gas outlet end; and
a partition partitioning the inlet cell and the outlet cell and having multiple pores through which the inlet cell and the outlet cell communicate with each other,
the coat layer being provided on wall surfaces of the pores,
the coat layer including a first inorganic oxide and the second inorganic oxide,
a mean particle diameter of the first inorganic oxide being larger than a mean particle diameter of the second inorganic oxide,
a weight ratio of the second inorganic oxide being from 10% to 50% inclusive when a total weight ratio of the first inorganic oxide and the second inorganic oxide is 100%.

2. The particulate filter according to claim 1, wherein the first inorganic oxide is a ceria-zirconia composite oxide, and the second inorganic oxide is alumina.

3. The particulate filter according to claim 2, wherein the weight ratio of the second inorganic oxide is from 20% to 30% inclusive.

4. The particulate filter according to claim 1, wherein the coat layer includes a catalyst metal functioning as a catalyst which is capable of oxidizing or reducing at least one exhaust gas component in the exhaust gas.

5. The particulate filter according to claim 2, wherein the coat layer includes a catalyst metal functioning as a catalyst which is capable of oxidizing or reducing at least one exhaust gas component in the exhaust gas.

6. The particulate filter according to claim 3, wherein the coat layer includes a catalyst metal functioning as a catalyst which is capable of oxidizing or reducing at least one exhaust gas component in the exhaust gas.
